(19) United States
(12) Patent Application Publication
(10) Pub. No.: US 2012/0186571 A1
(43) Pub. Date: Jul. 26, 2012

(54) Aqueous Cutting Fluid for Use with a Diamond Wiresaw

(76) Inventors: Linda Yi-Ping Zhu, Shanghai (CN); Henry Huan Chen, Shanghai (CN); Wanglin Yu, Midland (CN); Richard Yun Fei Yan, Shanghai (CN); Fang Li, Shanghai (CN)

(21) Appl. No.: 13/055,971

(22) PCT Filed: Oct. 16, 2009
(86) PCT No.: PCT/CN2009/001151

§ 371 Date: Jan. 26, 2011

(51) Int. Cl. C10M 141/02; B28D 5/00; B28D 1/08

(52) U.S. Cl. 125/21; 508/160

(57) ABSTRACT

Water-based cutting fluids for use with diamond wiresaws that are used for cutting or otherwise treating hard brittle materials, e.g., silicon ingots, comprise:
A. Water-soluble, polymeric dispersing agent, typically a polycarboxylate;
B. Optionally wetting agent;
C. Optionally defoamer;
B. Optionally corrosion inhibitor;
E. Optionally chelant;
F. Optionally biocide; and
G. Water.
   Typically water comprises at least 50 weight percent of the fluid, and the polycarboxylate is grafted with a polyalkylene glycol, e.g., polyethylene glycol.

### FIELD OF THE INVENTION

This invention relates to cutting fluids. In one aspect the invention relates to aqueous cutting fluids while in another aspect, the invention relates to aqueous cutting fluids for use with a diamond wiresaw, in yet another aspect the invention relates to an aqueous cutting fluid that comprises a polycarboxylate grafted with a polyalkylene glycol (PAG) while in still another aspect, the invention relates to a method of using the aqueous cutting fluid to treat a brittle material, e.g., a silicon ingot.

### BACKGROUND OF THE INVENTION

Wiresaws and similar equipment are used to cut hard, brittle materials, like silicon ingots, to produce wafers and other cut pieces that are used, in turn, in various industries, e.g., the semiconductor industry. To effectively cut these brittle materials, the wiresaws are used in conjunction with a cutting fluid. These fluids are slurry-based, e.g., they comprise a suspending fluid in combination with suspended abrasive particles, e.g., silicon carbide (SiC), and they are applied to the wiresaw at the interface of the saw and the brittle material, i.e., the workpiece. The abrasive particles need to be well distributed within the cutting fluid so that they can be well dispersed about the wire saw in order for the saw to perform well. The key to good dispersion and suspension of the abrasive particles is the viscosity of the cutting fluid. The fluids are typically held in a reservoir tank associated with the wiresaw, and transferred from the tank to the workpiece by pump and through a spray nozzle.

The cutting of a workpiece, e.g., a silicon ingot, produces swarf, i.e., cut debris from the workpiece, typically in the form of a fine powder. Often the swarf, e.g., silicon powder from a silicon ingot, has value but it is difficult, if not impossible, to recycle because it admixes intimately with the abrasive material, e.g., SiC, already in the cutting fluid. As a result, normally the slurry is replaced with fresh slurry after every one or two cuts.

Diamond wiresaw technology offers advantages over traditional wiresaw technology at several levels, particularly with respect to recycling swarf. In diamond wiresaw technology the abrasive particles are not suspended in a cutting fluid, but rather are embedded on the wire itself. This means that cutting fluids with less viscosity can be used and this, in turn, means that faster cutting speeds can be used. However, this means more heat is generated at the wiresaw/workpiece interface and this, in turn, requires the use of a cutting fluid with better cooling efficiency than that found with traditional cutting fluids.

While the use of cutting fluids with less viscosity and without abrasive particles imparts certain advantages to the operation of the wiresaw and the recycle of swarf, they must also accommodate the suspension and dispersion of swarf. Aggregation of the swarf can result in nozzle blockage and frequent cutting fluid replacement.

The cutting fluids must also exhibit several other important properties. For example, the cutting fluid must sufficiently wet and suspend the swarf so that it can be readily removed from both the diamond wiresaw and workpiece, but yet be readily removable from the swarf so as to leave little, if any, residue on the recycled particles. The cutting fluid should also exhibit little, if any, foaming so as not to risk damage of the pump or interruption of the operation of the wiresaw. Still further, the cutting fluid should be nonflammable.

### SUMMARY OF THE INVENTION

In one embodiment the invention is a cutting fluid comprising:

A. Water-soluble, polymeric dispersing agent, typically a polycarboxylate;

B. Optionally wetting agent;

C. Optional defoamer;

D. Optional corrosion inhibitor;

E. Optional chelant;

F. Optional biocide; and

G. Water.

In certain embodiments of the invention, the cutting fluid comprises one, two, three or all four of the optional components. The cutting fluid is water-based, i.e., it comprises at least 50, typically at least 60, more typically at least 80 and even more typically at least 90, percent by weight (wt %) water. Typically, the cutting fluid comprises loss than 98, more typically less than 97, wt % water. The water source can vary widely, and typically the water is free of particulates or other contaminants. Typically the water is de-mineralized and/or de-ionized. The polycarboxylate is typically grafted with a PAG, typically a polyethylene glycol (PEG).

The cutting fluids of this invention exhibit low viscosity, good cooling efficiency, good swarf suspension and dispersion, good wetting of swarf particles (particularly silicon particles) and cleaning of the diamond wiresaw and low foaming, generally non-sensitive to metal ions, and are nonflammable. The cutting fluids of this invention are also very stable at high temperatures and have a relatively long life, e.g., typically a fluid can be used for the cutting of ten or more workpieces before it needs to be replaced as opposed to the one or two workpieces with many current cutting fluids. Still further, any residual cutting fluids on silicon swarf are easily removed making for a facile recycle of the swarf.

In one embodiment the invention is a process of cutting a hard, brittle material with a wiresaw used in conjunction with a water-based cutting fluid, the process comprising the step of contacting the material with the wiresaw and cutting fluid under cutting conditions, the cutting fluid comprising:

A. Water-soluble, polymeric dispersing agent, typically a polycarboxylate;

B. Optionally wetting agent;

C. Optional defoamer;

D. Optional corrosion inhibitor;

E. Optional chelant;

F. Optional biocide; and

G. Water.

The cutting fluid is applied to the wiresaw, typically a diamond wiresaw, and typically at or just before the contact point, i.e., the interface, of the material and the wiresaw,

In one embodiment the invention is a cutting fluid pre-mix comprising:

A. Water-soluble, polymeric dispersing agent, typically a polycarhoxylate;

B. Optional Wetting agent;

C. Optional defoamer;

D. Optional corrosion inhibitor;

E. Optional chelant; and

F. Optional biocide.

In this embodiment the pre-mix is converted to a cutting fluid by the addition of water.

### BRIEF DESCRIPTION OF THE DRAWINGS

FIG. 1 is a photograph of the suspension results of different research samples at 23° C. and zero minutes.

FIG. 2 is a photograph of the suspension results of different research samples at 23° C. and sixty minutes.

FIG. 3 is a photograph of the suspension results of different research samples at 60° C. and sixty minutes.

### DESCRIPTION OF THE PREFERRED EMBODIMENT

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, definitions (to the extent not inconsistent with any definitions specifically provided in this disclosure), and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the component amounts of the cutting fluids and slurries and various process parameters.

“Compatible with the other components of the cutting fluid” and like terms mean that a particular component of the cutting fluid, e.g., wetting agent, defoamer, corrosion inhibitor, etc., will not block or significantly impede the performance of the other components of the cutting fluid.

Dispersants

The polymeric dispersants used in the practice of this invention are water soluble polymers that contain one or more negatively charged groups after dissociation in water. Examples of negatively charged groups include carboxylic, sulfonic, sulfinic, and phosphoric. Examples of the polymers include the polysulfones, polysulfides, polyesters, polyethers, polyacrylamides, polysaccharides, homopolymers and copolymers of acrylic acid, methacrylic acid, alkenyl sulfonic acid, aromatic alkenyl sulfonic acid, acrylamidosulfonic acid and maleic acid, known collectively as polycarboxylates. The polymers may include the units from water-insoluble co-monomers such as styrene, alkylstyrene, alkylacrylate and alkylmethacrylate in which the hydrogen on the alkyl group may be replaced by fluorine, chlorine, hydroxyl or other atoms or groups, and the alkyl may contain one or more oxygen, sulfur, or silicon atoms, and arylacrylate or arylmethacrylate, in an amount that can maintain sufficient water solubility of the polymers. Among the polycarboxylic acid-based polymer compounds identified above, particularly suitably used compounds include the alkaline metal salts and/or onium salts of the homopolymer of acrylic acid and/or the copolymer of acrylic acid and maleic acid. The weight-average molecular weight (Mw) of the polycarboxylic acid-based polymer compound and/or a salt is typically 1,000-1,000,000, more typically 1,000-100,000 and even more typically 10,000-30,000.

These polymers or the negatively charged repeat units in these polymers may be and are preferably grafted with one or more water soluble polymers, such as a polyalkylene glycol (PAG), particularly a polyethylene glycol (PEG), through different grafting linkages, such as ester, ether or a carbon-carbon bond. The polyalkylene glycols used in the practice of this invention are known compounds, and they are made by the polymerization of an alkylene oxide monomer or a mixture of alkylene oxide monomers initiated by one or more of water and a mono-, di- or polyhydric compound, and promoted by a catalyst under reactive conditions known in the art (see, for example, “Alkylene Oxides and Their Polymers”, Surfactant Science Series, Vol 35).

In one embodiment the initiator is ethylene or propylene glycol or an oligomer of one of them. In one embodiment, the initiator is a compound of the formula

R¹O—(CHR²CH₂O)ₘ—R³

in which R¹ and R³ are independently a C₁ to C₂₀ aliphatic or aromatic group with linear or branched structure and which may contain one or more unsaturated bonds, or hydrogen, with the proviso that at least one of R¹ and R³ is hydrogen; each R² is independently hydrogen, methyl, or ethyl; and m is an integer of 0 to 20. In one embodiment the starter compound is a hydrocarbon compound containing 3 or more hydroxyl groups, such as glycerol or sorbitol.

In one embodiment, the catalyst is a base, typically at least one of an alkali or alkaline earth metal hydroxide or carbonate, aliphatic amine, aromatic amine, or a heterocyclic amine. In one embodiment, sodium or potassium hydroxide is the base catalyst.

The alkylene oxide used as the monomer in the polymerization is a C₂ to C₈ oxide, such as ethylene oxide, propylene oxide, butylene oxide, hexene oxide, or octene oxide. In one embodiment, the alkylene oxide is ethylene or propylene oxide. Upon completion of the polymerization, the reaction mixture is vented and then neutralized by the addition of one or more acids. The neutralized polyalkylene glycol product has a pH value of 4.0 to 8.5.

In one embodiment of this invention the polyalkylene oxide is polyethylene oxide, or a water soluble copolymer of ethylene oxide (EO) and propylene oxide (PO), or a mono methyl, ethyl, propyl, or butyl ether of one of them, or a polyethylene oxide or a copolymer of EO and PC) initiated by glycerol. In one embodiment, the polyalkylene glycol has a molecular weight of 100-1,000, more typically of 200-600.

The weight percent of total polyalkylene oxide units in PAG-g-polycarboxylate is typically at least 40%, or more typically at least 50, 60, 70, or even more typically higher than 80%.

The PAG unit can be linked with a polycarboxylate structure or carboxylate unit through ether, ester, a C—C bond, amide, or imide. Ether and C—C bond linkages are preferred to provide better hydrolytic stability.

The PAG-g-polycarboxylate can be made by copolymerizing one or more monomers as listed above in preparing polycarboxylates with a polyethylene oxide or copolymer (random or block) of ethylene oxide and propylene oxide that is attached with a carbon-carbon double bond that is radically polymerizable with the unsaturated monomers. Examples of suitable macromers include polyoxyethylene or poly(oxyethylene-oxypropylene) acrylates, methacrylates, maleates, fumarates, and allyl ethers, or the like and mixtures of two or more of these compounds. Suitable macromers preferably have a number average molecular weight in the range of 500 to 10,000, and more preferred 600 to 5,000. Polyoxyethylene or poly(oxyethylene-oxypropylene) allyl ether macromer can be, for example, made by alkoxylation using allyl alcohol as initiator. Polyoxyethylene or poly(oxyethylene-oxypropylene) (meth)acrylate macromers can be produced by reacting a monoalkylether or monoarylether of polyalkylene glycol with (meth)acrylic acid using a known art, or can be produced by alkoxylating a hydroxyl alkyl (meth)acrylate as described in (EP1,012,203). PAG-g-polyearboxylate can also be made by treating a polycarboxylate with a mono alkylether or mono arylether of polyalkylene glycol. In addition, PAG-g-polycarboxylate can also be made by treating a FAG with (meth)acrylic acid, maleic acid, styrene sulfonic acid, (meth)allylsulfonic acid, or 2-acrylamido-2-methypropyl sulfonic acid under radical polymerization conditions as described in U.S. Pat. No. 4,528,334.

In one embodiment, the FAG is grafted to a polycarboxylate to form a PAG-g-polycarboxylate. In one embodiment the PAG-g-polycarboxylate is (methyl)PEG-g-polycarboxylate, especially a homo- or copolymer of acrylic acid, methacrylic acid, an alkenyl sulfonic acid, an aromatic alkenyl sulfonic acid, an acrylamidosulfonic acid or maleic acid. Without being bound by theory, the PAG-g-polycarboxylate strongly attaches to the surface of the swarf particles, particularly silicon particles, and this imparts a combination of high steric and electrostatic repulsion to the swarf particles. In turn, this greatly assists in the suspension and dispersion of the particles in the cutting fluid medium.

The amount of PAG-g-polycarboxylate in the cutting fluid, based on the total weight of the fluid, is typically at least 0.05, more typically 0.1, wt %. The maximum amount of PAG-g-polycarboxylate in the cutting fluid is mostly a matter of economics and convenience, but typically it is not in excess of 5, more typically 3, wt %.

Although typically used alone or in combination with one another, the PAG-g-polycarboxylate can be used in combination with one or more other dispersing agents that can attach to the surface of the swarf particles and impart a high steric and/or static repulsive character to the particles, e.g., polyacrylic acid and/or its derivatives. Typically in this instance, the PAG-g-polycarboxylate comprises at least 50, or 60, or 70 or 80 or 90, wt % of the dispersing agent.

The dispersants used in this practice can also be anionic or nonionic surfactants or a mixture of the two. Preferred nonionic surfactants that can be used as the dispersants have an HLB (Hydrophile Lipophile Balance) larger than 12. Examples include TERGITON 15-12, 15, 20, and 40, TERGITON NP-9 to 70, TERGITOL XH, XL, XD, TERGITOL 26-L series, and the like. Anionic surfactants include those that are soluble in water at room temperature (23° C.).

Wetting Agent

Any compound that is compatible with the other components of the cutting fluid and can effectively reduce the surface tension of an aqueous formulation, e.g., the cutting fluid, and thus effectively wet the surfaces of the workpiece and wiresaw can be used in the practice of this invention. The wetting agent is a surfactant or a surfactant mixture that is soluble or dispersible in water, and is typically anionic, nonionic or zwitterionic in charge.

Examples of anionic wetting agents include carboxylic acid salt based surfactants, such as sodium, potassium, or amine salts of fatty acids, acrylated aminoacids, acrylated polypeptides, and polyoxyalkylenated fatty alcohol carboxylates; sulfonie acid salt based surfactants, such as alkylbenzenesulfonates, petroleum sulfonates, α-olefin sulfonates, paraffin sulfonates, secondary n-alkanesulfonates, N-acyl-n-alkyltaurates, arylalkanesulfonates, alkyldiphenylether(di)sulfonates, sulfoccinate esters, alkylnaphthalenesulfonates, and isethionates; sulfuric acid ester salt based surfactants, such as sulfated alcohols, sulfated polyoxyalkylenated alcohols, sulfated triglyceride oils, fatty acid monoethanolamide sulfates, silicon-based surfactants, polyoxyalkylenated fatty acid monoethanolamide sulfates; and phosphoric or polyphosphoric acid esters. In the anionic surfactants, the hydrophobcs can be linear or branched hydrocarbon chains, linear or branched alkyl aryl, linear or branched alkyl phenol, and the hydrocarbon chain may contain unsaturated carbon-carbon bonds and can be partially or fully fluorinated.

Examples of nonionic surfactants that are suitable for use as the wetting agent include linear or branched primary or secondary alcohol ethoxylates or alkoxylates in which propylene oxide (PO), butylene oxide (BO), or higher alkylene oxide units may be included in different fashions, such as by block copolymerization, random copolymerization or end capping and in which the hydrocarbon chain may contain unsaturated carbon-carbon bonds and can be partially or fully fluorinated; amine alkoxylates; alkylphenol ethoxylates; block copolymer of ethylene and propylene oxide or butylenes oxide; long chain carboxylic acid esters, such like glyceryl and polyglyceryl esters of fatty acids, sorbitol or polyoxyethylene sorbitol esters; alkylpolyglycosides; ethoxylated acetylenic diols; and siloxane surfactants. In the nonionic surfactants, the terminal hydroxyl groups may be replaced by chlorine, alkylether, allylether, benzylether, acetate, or acetal as partially or fully “capped” surfactants.

Examples of zwitterionic surfactants that are suitable for use as the wetting agent include alkyl betaine, cocamidopropyl betaine, hydroxysultaiane, lecithin and sodium lauroamphoacetate. Additional zwitterionic surfactants are described in U.S. Pat. No. 4,301,044 and the references cited within it.

Preferred surfactants or surfactant combinations provide impart a surface tension to the cutting fluid of less than 45 mN/m. Typically the selection of the surfactant or surfactant combination results in no foaming, low foaming, or unstable foaming of the formulation. Preferably the surfactant is readily biodegradable as determined by an OECD 301 method. Surfactants with low surface tension based on secondary alcohol or high branched second alcohol ethoxylate (SAE) like TERGITOL™ TMN are preferred.

The amount of wetting agent in the cutting fluid, based on the total weight of the fluid, is typically at least 0.01, more typically 0.1, wt %. The maximum amount of wetting agent in the cutting fluid is mostly a matter of economics and convenience, but typically it is not in excess of 3, more typically 1, wt %.

Defoamer

Any compound that is compatible with the other components of the cutting fluid and will minimize or eliminate foaming of the cutting fluid while the fluid is stored, e.g., held in a reservoir tank of a diamond wiresaw apparatus, and is in use, e.g., pumped from the tank and applied to the wiresaw and workpiece surfaces, can be used in the practice of this invention. Exemplary defoamers include organo-modified polysiloxanes and polyethers. Exemplary defoamers include alkyl polysiloxane such as dimethyl polysiloxane, diethyl polysiloxane, dipropyl polysiloxane, methyl ethyl polysiloxane, dioctyl polysiloxane, diethyl polysiloxane, methyl propyl polysiloxane, dibutyl polysiloxane and didodecyl polysiloxane; organo-phosphorus compound such as n-tri-butyl phosphate, n-tributoxyethyl phosphate or triphenylphosphite, or a mixture therefore; and copolymer of poly alkylene oxide (ethylene oxide, propylene oxide and butylene oxide). Preferably are those water dispersible or soluble defoamer as described in U.S. Pat. No. 4,024,072 and the references cited within it.

Typically the cutting fluids of this invention comprise a defoamer. The amount of defoamer in the cutting fluid, based on the total weight of the fluid, is typically greater than zero, more typically at least 0.01 and even more typically 0.1, wt %. The maximum amount of wetting agent in the cutting fluid is mostly a matter of economics and convenience, but typically it is not in excess of 2, more typically 1, wt %.

Corrosion Inhibitor

Any compound that is compatible with the other components of the cutting fluid and will inhibit or eliminate corrosion of the surfaces of a diamond wiresaw apparatus with which the cutting fluid comes in contact in its usual storage and use can be used in the practice of this invention. Exemplary corrosion inhibitors include alkanolamines, borate esters, amine dicarboxylates and triazoles. Exemplary corrosion inhibitors include phosphorus containing chemicals such as orthophosphates, pyrophosphates, polyphosphates; hydroxycarboxylic acids and their salts, such as gluconic acids; glucaric acid; alkanolamines; nitrites; carboxylates; silicates; phosphonates and azole compounds such as benzotriazole, tolyltriazole, mercaptobenzothiazole, and halogenated azoles. More preferably are water dispersible or soluble corrosion inhibitors that exhibit good adhesion to substrates under flowing conditions as described in U.S. Pat. No. 6,572,789 and the references cited within it.

Typically the cutting fluids of this invention comprise a corrosion inhibitor. The amount of corrosion inhibitor in the cutting fluid, based on the total weight of the fluid, is typically greater than zero, more typically at least 0.01 and even more typically 0.1, wt %. The maximum amount of wetting agent in the cutting fluid is mostly a matter of economics and convenience, but typically it is not in excess of 2, more typically 1, wt %.

Chelant

Any compound that is compatible with the other components of the cutting fluid and that will bind or otherwise attach to a swarf particle or other particulate present in the cutting fluid due to the treatment of a workpiece or the formulation, transport or storage of the cutting fluid can be used in the practice of this invention. Exemplary chelants include ethylenediamine N′N′-tetraacetic acid (EDTA) and its salts and derivatives; hydroxyethyliminodiacetic acid (HEIDA and its salts and derivatives; methyl-glycine-diacetic acid (MGDA) and its salts and derivatives; and glutamic-N,N-diacetic acid (GLDA) and its salts and derivatives. Due to their biodegradability, HEIDA, MGDA and GLDA are often preferred.

Typically the cutting fluids of this invention comprise a chelant. The amount of chelant in the cutting fluid, based on the total weight of the fluid, is typically greater than zero, more typically at least 0.01 and even more typically 0.1, wt %. The maximum amount of wetting agent in the cutting fluid is mostly a matter of economics and convenience, but typically it is not in excess of 2, more typically 1, wt %.

Biocide

Any compound that is compatible with the other components of the cutting fluid and that will effectively minimize or eliminate cellular growth, e.g., bacterial, algae, etc., in the cutting fluid can be used in the practice of this invention. Cutting fluids are often formulated well in advance of their use, and are frequently stored for extended periods of time in the reservoir tanks of the equipment in which they are used, e.g., diamond wiresaws. The presence of cellular growth in the cutting fluids can diminish the performance of the fluid and result in clogs within the equipment, e.g., plugged spray nozzles. Exemplary biocides include triazine, oxazolidine, sodium omadine, and iodocarbamate.

Typically the cutting fluids of this invention comprise a biocide. The amount of biocide in the cutting fluid, based on the total weight of the fluid, is typically greater than zero, more typically at least 0.01 and even more typically 0.1, wt %. The maximum amount of wetting agent in the cutting fluid is mostly a matter of economics and convenience, but typically it is not in excess of 1, more typically 0.8, wt %.

Additives

The cutting fluid may contain other components or ingredients as well, such as polar solvents (e.g., alcohols, amides, esters, ethers, ketones, glycol ethers or sulfoxides), thickeners (e.g., xanthan gum, rhamsan gum or an alkyl-cellulose such as hydroxymethylcellulose, carboxymethylcellulose), dyes, fragrances and the like. These other ingredients are used in known manners and in known amounts. The total amount of additives, if present, in the cutting fluid is typically 0.01 to 10, more typically 0.05 to 5 and even more typically 0.1 to 3 percent by weight (wt %).

Formulation of the Cutting Fluids

The cutting fluids of this invention are formulated using known equipment and known techniques. The various components are typically added to one another in any order at room temperature, e.g., 23° C., or with low heat, e.g., 30° C. or 40° C., using conventional mixing equipment to provide agitation so as to promote good mixing of the components to produce a homogeneous mixture or blend. With water the dominant component of a fully formulated fluid, typically the other components are added to water.

In one embodiment the cutting fluid comprises at least one of a defoamer, corrosion inhibitor, chelant or biocide. In one embodiment the cutting fluid comprises at least two of a defoamer, corrosion inhibitor, chelant or biocide. In one embodiment the cutting fluid comprises at least three of a defoamer, corrosion inhibitor, chelant or biocide. In one embodiment the cutting fluid comprises all four of a defoamer, corrosion inhibitor, chelant or biocide.

In one embodiment the cutting fluid is fully formulated at a manufacturing facility, packaged and shipped, with or without intermediate storage, to an end user who may or may not further store it prior to use.

In one embodiment the cutting fluid is a pre-mix or concentrated formulation comprising most, if not all, of the ingredients other than a full compliment of water, e.g., water comprises less than 50 or 40 or 30 or 20 or 10 wt % of the concentrate, or is absent from the concentrate. In this embodiment the non-water components of the formulation are mixed, with or without a minor amount of water and using conventional mixing equipment and techniques, to form a pre-mix or concentrate that is then packaged and shipped, with or without intermediate storage, to an end user who may or may not further store it prior to use. The concentrate typically comprises, at a minimum, the PAG-g-polycarboxylate, wetting agent and chelant, dissolved in a minor amount of water, in amounts sufficient to provide their respective desired concentrations when the cutting fluid is fully formulated. When ready for use, the pre-mix or concentrate is simply diluted with water to the desired strength.

In another embodiment the cutting fluid is simply mixed as an on-site formulation.

Use of the Cutting Fluids

The cutting fluid is used in a known matter. Typically it is sprayed upon a cutting wire as a workpiece is brought into contact with the wire. The cutting wire is part of a cutting apparatus commonly known as a wiresaw or wire-web, and it usually comprises a row of fine wires arranged parallel to each other and at a fixed pitch. A workpiece is pressed against these fine wires (which typically have a diameter of 0.1-0.2 millimeters (mm) running in parallel with one another in the same direction, while the cutting fluid is supplied between the workpiece and the wires, the workpiece sliced into wafers by an abrasive grinding action. These wiresaws are described more fully in U.S. Pat. Nos. 3,478,732, 3,525,324, 5,269,275 and 5,270,271. For diamond wiresaws, the abrasive particles are embedded onto the moving web or wire.

The cutting fluids of this invention can be used in other treatments of a hard, brittle material, such as an ingot, crystal or wafer of silicon, gallium arsenide (GaAs) or gallium phosphide (GaP). These other treatments include without limitation grinding, etching and polishing. These fluids work particularly well in applications in which the abrasive particles are embedded on a substrate, e.g., wire, ceramic, etc.

The following examples are illustrative of certain embodiments of the present invention. All parts and percentages are based on weight except as otherwise indicated,

### SPECIFIC EMBODIMENT

### Chemicals and Equipment

The cutting fluid of this invention was prepared from the components described in Table 1 and had the composition as reported in Table 2. The cutting fluids of the comparative examples were all commercially acquired. None of the cutting fluids of the comparative examples comprise PAG-g-polycarboxylate.

TABLE 1
Components and Equipment

| Component | Composition | Source |
|---|---|---|
| Dispersing Agent | PEG-g-polycarboxylate | NA |
| | (Mw 10,000-30,000) | |
| Swarf | Silicon | Micron Metals, Inc. |
| Wetting Agent | Modified TERGITOL 15-S | The Dow Chemical |
| | Surfactant | Company |
| | (Secondary Alcohol | |
| | Alkoxylated) | |
| Defoamer | DK-Q1 1247 | Dow Corning |
| | (Organo-Modified | |
| | Polysiloxane) | |
| Corrosion Inhibitor | Borate Esters | |
| Chelant | VERSENE 4Na | The Dow Chemical |
| | | Company |
| Biocide | BIOBAN) | The Dow Chemical |
| | | Company |
| Tensometer | qK12-MK6 | KRUSS |
| Mixer | MINI VORTEXER | IKA Works |
| | MV1 | Laboratory |
| Ross Miles Apparatus | CH-1015 | Shanghai Tian Ping |

TABLE 2
Composition of the Inventive Cutting Fluid

| | Dosage |
|---|---|
| Component | (wt %) |
| PEG-g-Polycarboxylate | 2.5 |
| Modified TERGITOL 15-S | 0.5 |
| DK-Q1 1247 | 0.1 |
| Borate Esters | 0.01-0.1 |
| VERSENE 4Na | 0.1 |
| BIOBAN | 0.2 |
| Pure Water | q.s. |
| Total | 100 |

Performance Tests

### Surface Tension

The surface tension of the cutting fluids was tested with a model K12-MK6 tension meter from KRUSS. The results are reported in Table 3. Solutions with low surface tension (less than 30 mN/m) can wet the dirt and assist in the facile removal of the dirt from a contaminated wire. All cutting fluids show a surface tension lower than 30 mN/m except Comparative CF-3.

TABLE 3
Surface Tension Testing Results

| Cutting Fluid | Surface tension (mN/m) |
|---|---|
| Inventive CF | 29.52 |
| Comparative CF-1 | 24.69 |
| Comparative CF-2 | 21.36 |
| Comparative CF-3 | 42.28 |

### Foaming

The tendency to form and hold foam was tested using the Ross Miles method (ASTM D1173). The results are reported in Table 4.

TABLE 4
Foaming Test Results

| Examples | Initial Foaming (cm) | Remark |
|---|---|---|
| Inventive CF | 1.5 | 4 sec: no foaming* |
| Comparative CF-1 | 1.1 | 2 sec: no foaming |
| Comparative CF-2 | 1.0 | 2 sec: no foaming |
| Comparative CF-3 | 1 | >120 sec, still 0.2 cm |

*Foaming is very unstable.

### Suspension Capacity

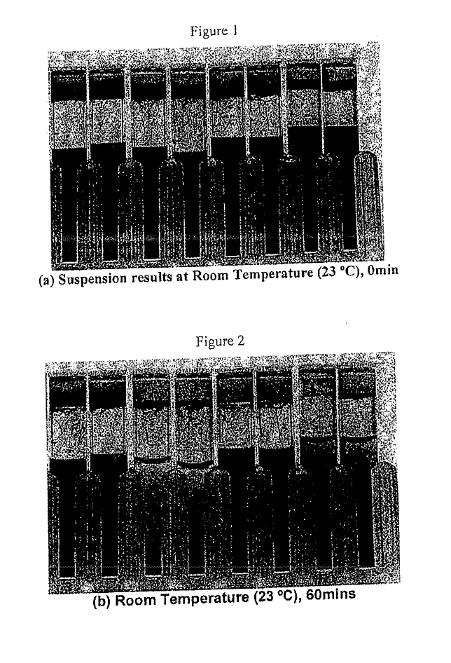

The suspension results for the inventive and comparative cutting fluid samples at different times and temperatures are shown in FIGS. 1-3. The sample sequence left to right is: Comparative CF-3, Comparative CF-3, Comparative CF-1, Comparative CF-1, Inventive CF, Inventive CF, Comparative CF-2, and Comparative CF-2. The load of silicon swarf was 10 wt %.

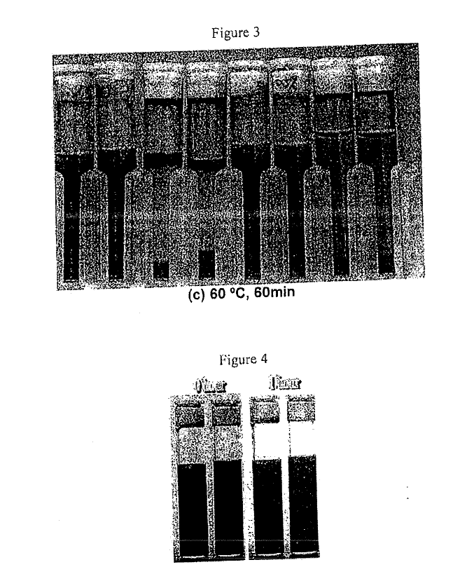

The swarf particles are dispersed in the cutting fluid samples to form uniform slurries at the beginning (FIG. 1). At room temperature and after the slurries have stood still for 1 hour, most of the silicon swarf settled to the bottom of the vials of Comparative CF-1 and 2 samples and their aqueous phase became totally clear. Inventive CF (which contained 2.5 wt % PEG-g-polycarboxylate) and Comparative CF-3, most silicon swarf particles are still well suspended in the vials (FIG. 3). At 60° C. the suspension behavior of all samples is similar as that at room temperature.

The results show that the dispersing ability for the different cutting fluids at room temperature and 60° C. is as follows: Inventive. CF=CF-3>>CF-1 and CF-2. Inventive CF shows at 2.5 wt % PEG-g-polycarboxylate exhibits excellent suspension capacity for silicon swarf.

When a nonionic surfactant, e.g., TERGITOL, NP-9 (calculated HIB value of 12.9 determined by dividing, the weight percent of EO component by 5), is used as the dispersant, the dispersion of Si swarf is still well dispersed after one hour of steady standing at room temperature (FIG. 4).

Although the invention has been described with certain detail through the preceding specific embodiments, this detail is for the primary purpose of illustration. Many variations and modifications can be made by one skilled in the art without departing from the spirit and scope of the invention as described in the following claims.

What is claimed is:

1. A cutting fluid comprising in weight percent based on the weight of the cutting fluid, at least:
A. 0.05% of a water-soluble, polymeric dispersing agent comprising one or more groups that are negatively charged upon dissociation in water;
B. Optionally 0.01% wetting agent;
C. Optionally 0.01% defoamer;
D. Optionally 0.01% corrosion inhibitor;
E. Optionally 0.01% chelant;
F. Optionally 0.01% biocide; and
G. 50% water.

2. The cutting fluid of claim 1 comprising:
A. 0.05-5% polycarboxylate dispersing agent;
B. 0.01-3% wetting agent;
C. 0.01-2% defoamer;
D, 0.01-2% corrosion inhibitor;
E. 0.01-2% chelant;
F. 0.01-1% biocide; and
G. 80% water.

3. The cutting fluid of claim 2 in which the
A. polycarboxylate dispersing agent is PAG-g-polycarboxylate and the polycarboxylate of the PAG-g-polycarboxylate comprises units derived from acrylic acid;
B. Wetting agent is a secondary alcohol alkoxylate;
C. Defoamer is an organo-modified polysiloxane or polyether;
D. Corrosion inhibitor is at least one of an alkanolamine, borate ester, amine dicarboxylate or triazole;
E. Chelant is at least one of ethylenediamine N′N′-tetraacetic acid (EDTA) and its salts and derivatives; hydroxyethyliminodiacetic acid (HEIDA and its salts and derivatives; methyl-glycine-diatetic acid (MGDA) and its salts and derivatives; or glutamic-N,N-diatetic acid (GLDA) and its salts and derivatives; and
F. Biocide is at least one of triazine, oxazolidine, sodium omadine or iodocarbamate.

4. A process of cutting a hard, brittle material with a wiresaw used in conjunction with a water-based cutting fluid, the process comprising the step of contacting the material with the wiresaw and cutting fluid under cutting conditions, the cutting fluid comprising:
A. 0.05% of a water-soluble, polymeric dispersing agent comprising one or more groups that are negatively charged upon dissociation in water;
B. Optionally 0.01% wetting agent;
C. Optionally 0.01% defoamer;
D. Optionally 0.01% corrosion inhibitor;
E. Optionally 0.01% chelant;
F. Optionally 0.01% biocide; and
G. 50% water.

5. The process of claim 4 in which the cutting fluid comprises:
A. 0.05-5% polycarboxylate dispersing agent;
B. 0.01-3% wetting agent;
C. 0.01-2% defoamer;
D. 0.01-2% corrosion inhibitor;
E, 0.01-2% chelant;
F. 0.01-1% biocide; and
G. 80% water.

6. The process of claim 5 in which the cutting fluid comprises
A. PAG-g-polycarboxylate and the polycarboxylate of the PAG-g-polycarboxylate comprises units derived from acrylic acid;
B, Wetting agent is a secondary alcohol alkoxylate;
C. Defoamer is an organo-modified polysiloxane or polyether;
D Corrosion inhibitor is at least one of an alkanolamine, borate ester, amine dicarboxylate or triazole;
E. Chelant is at least one of ethylenediamine N′N′-tetraacetic acid (EDTA) and its salts and derivatives; hydroxyethyliminodiacetic acid (HEIDA and its salts and derivatives; methyl-glycine-diacetic acid (MGDA) and its salts and derivatives; or glutamic-N,N-diacetie acid (GLDA) and its salts and derivatives; and
F. Biocide is at least one of triazine, oxazolidine, sodium omadine or iodocarbamate.

7. The process of claim 6 in which the hard brittle material consists of silicon, GaAs or GaP.

8. The process of claim 7 in which the wiresaw is a diamond wiresaw.

9. A cutting fluid concentrate comprising:
A. PAG-g-polycarboxylate dispersing agent;
B. Optionally wetting agent;
C. Optionally defoamer;
D. Optionally corrosion inhibitor;
E. Optionally chelant; and
F. Optionally biocide.

10. The cutting fluid concentrate of claim 9 in which the wetting agent, defoamer, corrosion inhibitor, chelant and biocide are present, and the:
A. PAG of the PAG-g-polyoarboxylate is PEG and the polycarboxylate of the PAG-g-polycarboxylate comprises units derived from acrylic acid;
B. Wetting agent is a secondary alcohol alkoxylate;
C. Defoamer is an organo-modified polysiloxane or polyether;
D Corrosion inhibitor is at least one of an alkanolamine, borate ester, amine dicarhoxylate or triazole;
E. Chelant is at least one of ethylenediamine N′N′-tetraacetic acid (EDTA) and its salts and derivatives; hydroxyethyliminodiacetic acid (HEIDA and its salts and derivatives; methyl-glycine-diacetic acid (MGDA) and its salts and derivatives; or glutamic-N,N-diacetic acid (GLDA) and its salts and derivatives; and
F. Biocide is at least one of triazine, oxazolidine, sodium omadine or iodocarbamate.
